(19) United States
(12) Patent Application Publication
(10) Pub. No.: US 2003/0146195 A1
(43) Pub. Date: Aug. 7, 2003

(54) Particle production

(76) Inventor: Michael Cleary, Thurstaston (GB)

Correspondence Address: COLLARD & ROE, 1077 Northern Boulevard, Rosln, NY, 11576, US

(21) Appl. No.: 10/068,611

(22) Filed: Feb. 6, 2002

(51) Int. Cl. B23K 26/38

(52) U.S. Cl. 219/121.69

(57) ABSTRACT

A method of producing batches of micro particles, comprises:

e) affixing a substrate sheet to a support

f) cutting the substrate sheet by means of a laser device to define a plurality of micro particles;

g) either before, after or during the cutting the substrate sheet, marking the region of the substrate sheet defining each micro particle by means of a laser device with a code or other identifying marking, said code or other identifying marking being unique to that particular batch of micro particles to uniquely identify that batch; and

h) removing the micro particles from the support by means of a solvent.

Preferably a single laser device is used for cutting the substrate sheet and marking the micro particles. Alternatively, separate laser devices may be used for respectively cutting the substrate sheet and marking the micro particles.

The present invention relates to a method for producing batches of large numbers of micro particles marked in such a manner as to uniquely identify each batch.

Known methods for producing batches of identically and uniquely marked micro particles are based on a code formed from a plurality of digits, said digits being reproduced on a substrate by means of photo reduction, the substrate then being cut to form a batch of micro particles. The required numerical code is one sequence of multiple sequences of numbers. This results in the particles being excessively large due to the inclusion of irrelevant information.

Current laser marking techniques are based on substrates typically used in the micro-electronics industry to manufacture semi-conductors. These substrates are generally based on wafers of gold, silver or aluminium or of materials such as silicon or silicon dioxide. The particles are formed on the wafer through the deposition and etching processes of silicon micro-machining.

The prior art method for producing micro particles comprise a number of separate processes which increases the cost of production. In particular, separate processes are required for the marking of individual micro particles and the cutting of the substrate from which the micro particles are formed.

According to the invention there is provided a method of producing batches of micro particles, comprising:

a) affixing a substrate sheet to a support

b) cutting the substrate sheet by means of a laser device to define a plurality of micro particles;

c) either before, after or during the cutting the substrate sheet, marking the region of the substrate sheet defining each micro particle by means of a laser device with a code or other identifying marking, said code or other identifying marking being unique to that particular batch of micro particles to uniquely identify that batch; and

d) removing the micro particles from the support.

Preferably a single laser device is used for cutting the substrate sheet and marking the micro particles. Alternatively, separate laser devices may be used for respectively cutting the substrate sheet and marking the micro particles.

Preferably said code or other identifying marking is discernible by means of a contrast or colour, reflectance or light transmission.

In one embodiment of the invention, the substrate comprises a plastic material having a metal layer thereon, preferably formed by vacuum deposition, said code is formed by evaporation of the metal layer by means of the laser device to define a pattern or discernible code on each micro particle.

In an alternative embodiment of the invention, the substrate comprises a plastic material and said code is formed by burning holes in said substrate to define a pattern or discernible code on each micro particle.

Preferably said pattern or discernible code comprises a series of digits.

The substrate sheet may be affixed to the support by means of a suitable adhesive. Preferably the support comprises a flat sheet of inert material. In a preferred embodiment the support is formed from glass. Alternatively the support may be formed from a suitable plastic.

Preferably the micro particles are removed from the support by the use of a suitable solvent.

The method may include the further step of suspending the micro particles in a suitable medium to allow the micro particles to be painted or sprayed onto goods to be marked. Where the substrate comprises an aluminium material or an aluminium layer deposited on a plastic base, the medium in which the micro particles are suspended may contain an anti oxidant to prevent oxidation of the aluminium.

During steps (b) and (c) of the method, said support, and substrate sheet affixed thereto, may be mounted beneath one or more fixed laser devices such that the support is movable in a plane perpendicular to the axis of the one or more laser devices. Preferably the movement of the support with respect to the one or more laser devices is controlled by means of a computer.

According to a further aspect of the invention there is provided a batch of micro particles produced by a method according to the first aspect of the invention.

The present invention will be described further, by way of a non-limiting example of a method of producing a batch of micro particles in accordance with the invention.

A sheet of suitable substrate typically 30 cm by 30 cm, such as a plastic/metal laminate with the metal layer applied via vacuum deposition or a plastic sheet, is adhered to a flat and inert support, preferably a flat sheet of glass by means of a suitable adhesive. A spray adhesive such as 3M Spray Mount Adhesive has been found to be particularly suitable.

The support, along with the substrate adhered thereto, is mounted on a stage movable in a plane perpendicular to a laser system. Movement of the stage in x-y coordinates is controlled by a computer.

The computer controls operation of the stage and the laser system such that the laser system marks the substrate with the desired code, preferably through the use of a mask marking several areas at once. The marking can be performed in several ways, but preferably through the formation of contrast either in colour, reflectance or light transmission of the thus formed micro particle.

Prior to, simultaneously with or subsequent to the marking process described above, the micro particles are separated through the use of either the same or a different laser which cuts through the substrate, which is still adhered to the support, in a predetermined manner, forming individual micro particles of predefined dimensions.

The particles so formed as removed from the support through the use of a suitable solvent acting on the adhesive holding the substrate to the support. The particles are then suspended in a suitable medium, the composition of which is dependent upon the nature of the particles and the use to which they are intended to be put.

The preferred method of application of the particles is by either painting or spraying this medium onto various goods to be marked. The particles can be used in numerous ways such as to prove ownership, to provide a means of tracking or in brand protection.

Two main method of marking are envisaged.

The first of these involves the use of a plastic/metal laminate with the metal layer applied to a plastic base by means of vacuum deposition. The digits of the code applied to each particle is formed by evaporation of the metal layer through the action of the laser, the digits then being determined through the contrast between the metal and the plastic surfaces. Such laminates are commercially available, although the preferred laminate is 25 micron white P.E.T. with a 0.5 micron layer of aluminium.

The second method of marking involves the use of a plastic substrate, preferably 10 micron thick P.E.T., the digits of the code being formed on the substrate by the burning of holes in the substrate through the action of the laser to form a pattern or a discernible code.

The choice of adhesive for adhering the substrate to the support is important because variations in the combined thickness of the support and substrate can result in the surface of the substrate falling outside of the laser focus. Sprayable adhesives have been found to provide the most reproducible layers and the preferred of these is 3M Spray Mount Adhesive.

Glass sheet is the preferred material for the support due to the tighter tolerances on flatness provided over plastic materials.

Where a plastic/metal laminate is used for the substrate material, the stability of such has been found to be unreliable in certain solvent based systems (where a solvent based suspension medium is used for the application of the micro particles). The preferred metal is aluminium, however this has been found to oxidise in most solvent based systems. This problem has been overcome by the inclusion of an anti-oxidant in the formulation of the suspension medium, the preferred being a proprietary product known as SER AD 579 sold by Banner Chemicals.

1. A method of producing batches of micro particles, comprising:
a) affixing a substrate sheet to a support
b) cutting the substrate sheet by means of a laser device to define a plurality of micro particles;
c) either before, after or during the cutting the substrate sheet, marking the region of the substrate sheet defining each micro particle by means of a laser device with a code or other identifying marking, said code or other identifying marking being unique to that particular batch of micro particles to uniquely identify that batch; and
d) removing the micro particles from the support.

2. A method according to claim 1, wherein a single laser device is used for cutting the substrate sheet and marking the micro particles.

3. A method according to claim 1, wherein separate laser devices are used for respectively cutting the substrate sheet and marking the micro particles.

4. A method as claimed in any preceding claim wherein said code or other identifying marking is discernible by means of a contrast or colour, reflectance or light transmission.

5. A method according to any preceding claim, wherein the substrate comprises a plastic material having a metal layer thereon, preferably formed by vacuum deposition, said code is formed by evaporation of the metal layer by means of the laser device to define a pattern or discernible code on each micro particle.

6. An method according to any of claims 1 to 4, wherein the substrate comprises a plastic material and said code is formed by burning holes in said substrate to define a pattern or discernible code on each micro particle.

7. A method as claimed in either claim 5 or claim 6, wherein said pattern or discernible code comprises a series of digits.

8. A method according to any preceding claim, wherein the substrate sheet is affixed to the support by means of a suitable adhesive.

9. A method according to any preceding claim, wherein the support comprises a flat sheet of inert material.

10. A method according to claim 9, wherein the support is formed from glass or a suitable plastic.

11. A method according to any preceding claim, wherein the micro particles are removed from the support by the use of a suitable solvent.

12. A method according to any preceding claim, including the further step of suspending the micro particles in a suitable medium to allow the micro particles to be painted or sprayed onto goods to be marked.

13. A method according to claim 12, wherein the medium in which the micro particles are suspended contains an anti oxidant.

14. A method according to any preceding claim, wherein, during steps (b) and (c) of claim 1, said support, and substrate sheet affixed thereto, is mounted beneath one or more fixed laser devices such that the support is movable in a plane perpendicular to the axis of the one or more laser devices.

15. A method according to claim 14, wherein the movement of the support with respect to the one or more laser devices is controlled by means of a computer.
